(19) United States
(12) Patent Application Publication
(10) Pub. No.: US 2016/0222944 A1
(43) Pub. Date: Aug. 4, 2016

(54) WIND TURBINE AND METHOD FOR OPERATING A WIND TURBINE

(71) Applicant: WOBBEN PROPERTIES GMBH, Aurich (DE)

(72) Inventors: Jürgen Stoltenjohannes, Aurich (DE); Thomas Bohlen, Südbrookmerland (DE); Harro Harms, Wiesmoor (DE); Albrecht Brenner, Aurich (DE); Rainer Schluter, Aurich (DE)

(21) Appl. No.: 14/649,893

(22) PCT Filed: Dec. 5, 2013
(86) PCT No.: PCT/EP2013/075606

§ 371 Date: Jun. 4, 2015

(30) Foreign Application Priority Data
Dec. 5, 2012 (DE) 10 2012 222 323.1

(51) Int. Cl. F03D 7/02

(52) U.S. Cl. CPC F03D 7/0204; F03D 7/0224

(57) ABSTRACT

The present invention relates to a method for operating a wind turbine having a rotor with rotor blades and an essentially horizontal rotation axis for generating electrical energy from wind energy. According to the invention, it is proposed for the wind turbine to be aligned such that the azimuth position of the wind turbine departs by an azimuth adjustment angle from an alignment into the wind, and/or that the blade angle of the rotor blades is adjusted in cyclic rotation such as to reduce alternating loads that are caused by a height profile of the wind.

### BACKGROUND

1. Technical Field

The present invention relates to a method for operating a wind turbine for generating electrical energy from wind energy. The present invention further relates to a corresponding wind turbine having a rotor with rotor blades and an essentially horizontal rotation axis.

2. Description of the Related Art

Wind turbines are generally known, and nowadays the most common wind turbine type is the so-called horizontal axis wind turbine. Here, a rotor with rotor blades rotates about an essentially horizontal rotation axis. The rotation axis may be slightly tilted, e.g., by a few degrees, but it is still referred to as a horizontal axis by experts in order to distinguish it from completely different installation types, such as, for example, so-called Darrieus rotors.

The rotor of such a horizontal axis wind turbine over-sweeps an essentially vertical rotor plane or, respectively, disk area. Such disk area extends considerably in a vertical direction even with modern wind turbines. When making a full rotation, the tip of each rotor blade reaches the lowest point of such disk area once at a 6 o'clock position, and the highest point of such disk area at a 12 o'clock position. Such highest point may be higher than the lowest point by a multiple. For example, an ENERCON type E-82 wind turbine has a rotor diameter of 82 m, and there is a variant where the hub height—i.e., the axis height or, respectively, the center of the disk area—is arranged at a height of 78 m. Here, the lowest point is at a height of 37 m, while the highest point is at a height of 119 m. Hence, the highest point lies more than three times higher than the lowest point. Even with larger hub heights, there will still be a considerable difference in height between such lowest and highest point of the disk area.

Under practical aspects one must consider that the wind shows a natural height profile, meaning that for relevant heights it is higher or stronger with increasing height above ground. The difference in height of the over-swept disk area thus results in the wind present here having a correspondingly varying strength. Accordingly, the wind at the lowest point will be the weakest, while the wind at the highest point will be the strongest. In other words: wind turbines are impacted by more or less distinct shear flows within the atmospheric boundary layer. This can be referred to as wind height profile, and during the operation of a wind turbine such wind height profile causes a fluctuation of the local blade angle at the rotor blade, so that unwanted alternating loads and a non-homogenous torque output may occur. Increased noise emissions caused by a stall at the rotor blade may also occur.

Please note that the present invention examines, and relates, in particular, to these problems caused by the wind height profile. To make things more complicated, winds of varying turbulence may, of course, also lead to different observations. However, these problems will not be considered here as they can be often neglected, or—insofar as they cannot be neglected—they require separate consideration, which is not the subject matter of the present invention.

To address this or these problems, U.S. Pat. No. 6,899,523 has already proposed a blade design featuring different sections that are designed for different tip speed ratios. A so-called integrated blade design is known from US 2010/0290916, where the rotor blade is designed such that it shows a still satisfactory drag ratio even over a blade angle or, respectively, angle of incidence that is as large as possible. It was thus proposed therein to not optimize the blade towards a single blade angle that is as ideal as possible, but to rather allow for a slightly larger area in relation to the blade angle, even if the drag ratio should no longer be quite optimal for an ideal blade angle.

However, the differences caused by the wind height profile and thus certain problems may also increase with the increasing size of wind turbines.

In the priority application that pertains to the present application, the German Patent and Trademark Office has researched the following prior art: U.S. Pat. No. 6,899,523 B2, US 2010/0 074 748 A1, US 2010/0 078 939 A1, US 2010/0 092 288 A1, US 2010/0 290 916 A1 and BOSSANYI, E. A.: Individual Blade Pitch Control for Load Reduction. In: Wind Energy, Vol. 6, 2003, p. 119-128. Online ISSN: 1099-1824.

### BRIEF SUMMARY

One or more embodiments are directed to methods of operating a wind turbine where loads caused by the wind height profile and noise emissions are reduced and/or outputs are increased. At least one alternative solution should be proposed.

In accordance with one embodiment of the invention, a method according to claim 1 is proposed.

What is thus operated is a wind turbine featuring an aerodynamic rotor with rotor blades having an essentially horizontal rotation axis for generating electrical energy from wind energy.

The wind turbine is aligned such that the azimuth position departs by an azimuth adjustment angle from an alignment exactly into the wind. So far, wind turbines have been aligned exactly into the wind with their azimuth position so as to be able to exploit the wind in the best possible way. It is now, however, proposed to deliberately change the wind turbine's azimuth position or azimuth alignment with regard to this ideal alignment to the wind, namely by the azimuth adjustment angle. It was recognized that by changing the azimuth position, alternating loads on the rotor blades that are caused by the wind height profile can be reduced. The rotor blade will then no longer move at a full right angle, but slightly slantwise to the wind. If the azimuth position is thus changed, as appropriate, this means that each rotor blade will, as a result of such slantwise movement to the wind, move slightly away from the wind in the upper part of the disk area and then slightly towards the wind in the lower part of the disk area.

According to one embodiment, it is proposed for the wind turbine to depart to the right from the alignment into the wind when looking from the wind turbine in the direction of the wind, or, respectively, to depart in its azimuth position clockwise to the alignment into the wind when looking down onto the wind turbine. The wind turbine is thus adjusted to the right in its azimuth position. This has to do with the rotational direction of the rotor, which normally, when looking away from the wind turbine, rotates counterclockwise or, respectively, when looking at it from the front, that is, from the direction of the wind and onto the wind turbine, as intended, rotates clockwise. Should a wind turbine, contrary to this common rotational direction, rotate clockwise when looking away from the wind turbine or, respectively, rotate counterclockwise when looking from the front, that is, from the direction of the wind and onto the wind turbine, as intended, then the proposed azimuth position must of course be adjusted accordingly.

An azimuth adjustment angle within a range of 0.5° to 3.5° may already have advantageous effects, such as equalization of the blade load, i.e., reduction of the alternating loads. This range lies preferably between 1° and 3°; what is proposed, in particular, is a range of 1.5° to 2.5°, which has led to very positive effects in tests. Such comparatively low values also have the advantage that one must reckon with only a minor loss in output due to the non-ideal adjustment of the azimuth angle. As a first approximation, a dependence of the output on the adjustment of the azimuth angle to the wind is described by means of a cosine function. This means that for angle 0, i.e., an ideal alignment, the maximum value 1 exists, which, as we know from the cosine function, will hardly change in the case of minor angular deviations towards zero.

According to one embodiment, it is proposed to select the azimuth adjustment angle depending on the prevailing wind speed. One may, for example, select a small azimuth adjustment angle in weak wind conditions to displace the wind turbine to an only lesser extent from an ideal alignment directly into the wind, since, for example, in weak wind conditions, the absolute load is decreased and alternating loads therefore have a lesser impact and, in particular, cause less fatigue. Here, the prevailing wind speed may be recorded for example by means of a wind turbine anemometer or by other means.

It is proposed furthermore, or as an alternative, to adjust the respective rotor blade angle in cyclic rotation such as to reduce alternating loads that are caused by the wind's height profile. Here, blade angle means the blade angle of the rotor blades, which is also referred to as pitch angle. The blade angle may be, in particular, adjusted such that it is displaced slightly out of the wind in the upper part of the disk area and slightly into the wind in the lower part of the disk area. This is to take place, in particular, in cyclic rotation, i.e., not based on regular readings, and thus preferably not in the form of an adjustment control, but based on constant values that are assigned to each cycle position or to areas of the cycle position of each blade. Such assignment may also consider further parameters, such as prevailing wind speed, local dependence, wind direction, and time of the year or day. There is no need to constantly measure the blade load by, for example, measuring the blade deflection. Accordingly, possible stability problems are also prevented due to an adjustment control, although the use of an adjustment control may also be an option of implementation.

The reduction in alternating loads through cyclic pitch control of the blades may be geared to previously recorded values or previously calculated values or empirical values of this or other wind turbines. Accordingly, the blade angle is individually adjusted for each and every rotor blade. Such individual adjustment may take place such that an identical adjustment function is used for each blade, which is, however, displaced by 120° from one blade to another, if the wind turbine features, for example, three rotor blades. What is important here is that each rotor blade has its own pitching mechanism.

According to one embodiment, it is proposed to perform a cyclic pitch control such that the angle of incidence is kept as constant as possible. This is proposed accordingly for each and every rotor blade. The angle of incidence here is the angle at which the apparent wind blows against the rotor blade at the blade's tip. An area in the outer third of the rotor blade may also be used as a basis instead of, or in addition to, the blade tip, in particular at 70%, 75%, 80% or a range of 70% to 80% of the rotor blade length, measured from the rotor axis. Here, the apparent wind is the vectorial addition of the actual wind and the headwind, which is caused by the rotation of the rotor and thus by the movement of the blade tip. As described in the beginning, such apparent wind changes with height, both in terms of its amplitude and its angle. It is proposed to turn the blade such that it adapts to the direction of the apparent wind in the area of its tip. The rotor blade is thus turned slightly more strongly into the wind at a 12 o'clock position, i.e., when the rotor blade stands vertically upwards, than at a 6 o'clock position, i.e., when it is at the very bottom. The interim values follow accordingly. This results not only in an adjustment or partial adjustment to the direction of the apparent wind such that this adjustment is desirable in terms of flow, but the stronger turning into the wind of a rotor blade that is at a 12 o'clock position—i.e., generally speaking, in the upper range—also causes an enhanced load absorption by the rotor blade.

Another embodiment of the invention proposes to adjust the blade angle of each rotor blade by predetermined values, depending on its respective cycle position, whereby, in particular, the predetermined values have been previously recorded in a table and/or are provided by a function that depends on the cycle position. The embodiment thus proposes to control the blade angle of each rotor blade individually, depending on the respective cycle position of such rotor blade. The position of the rotor and thus, at least after a simple conversion, the position of each rotor blade is often known when operating a wind turbine or can be easily determined. Based on this, each rotor blade angle is adjusted according to predetermined values without requiring any measuring. The predetermined values may be provided in a table which was previously recorded, calculated, or prepared by means of simulation. Such table may also consider further parameters, such as wind speed or site-related height profiles that depend on wind direction.

Another or an additional option is to specify such cyclic blade adjustment based on a function. For example, the rotor blade angles α₁, α₂ and α₃ may be specified in the form of the following functions for a wind turbine with, for example, three rotor blades:

α₁=α_{N}+cos(β).α_{A}

α₂=α_{N}+cos(β+120°).α_{A}

α₃=α_{N}+cos(β+240°).α_{A}

Here, α_{N} describes a calculated or specified blade angle that is calculated as is common in prior art, namely without considering a wind height profile. Angle β describes the cycle position of the rotor blade, with β=0° equaling a 12 o'clock position of the respective rotor blade. α_{A} is the blade adjustment angle.

Preferably, the blade angle is controlled individually and depending on the prevailing wind speed, in particular such that it is controlled depending on the prevailing wind speed and cycle position of the respective rotor blade. Consideration of either parameter may be done, for example, in the form of a two-dimensional table featuring the respective blade angles, which are entered as a function of the cycle position and prevailing wind. Another option would be to make a calculation according to the above equations, with the adjustment angle α_{A} depending on the prevailing wind speed and being adjusted as a function thereof, for example based on a respective function or previously determined table values, to just name two examples.

As already indicated above, a common normal rotor blade angle is preferably specified for all rotor blades when in operation, and every single rotor blade is varied around such single normal rotor blade angle depending on its cycle position, in particular within a specified blade angle interval. One possibility for doing this is to use the above equations, according to which the rotor blade angle varies around the adjustment angle ±α_{A}. Accordingly, a variation within the interval [α_{N}−α_{A}; α_{N}+α_{A}] takes place in the example.

According to yet another embodiment, it is proposed for the wind turbine to operate at a profile operating point that differs from a normal operating point. Here, the normal operating point is—in particular in the partial-load operational range—one that features a normal blade angle that is designed for the prevailing wind but without consideration of a wind profile, and that moreover features a normal alignment of the azimuth position, where the wind turbine is facing directly into the wind. The profile operating point provides for a profile azimuth position that deviates by the azimuth adjustment angle from the normal alignment. It moreover provides for a profile blade angle that deviates by a blade adjustment angle from the normal blade angle. It is thus proposed to combine, i.e., to simultaneously perform, an adjustment of the azimuth position and blade angle in order to reduce a load.

Preferably, a first profile operation is selected, where the blade adjustment angle—based on a 12 o'clock position of the respective rotor blade—is opposite the azimuth adjustment angle. This means that in the 12 o'clock position, the rotor blade is only slightly displaced compared to normal operation, as the two angles cancel each other out, at least partially. It should be noted that adjusting the azimuth angle and rotor blade angle may result in different effects, so that a synergy having a positive effect on the load can be achieved despite the partial cancellation.

According to another embodiment, a second profile operation is proposed, where the blade adjustment angle and azimuth adjustment angle adjust the rotor blade in the same direction in relation to a 12 o'clock position of the respective rotor blade. Here, the combination of both angles thus increases the blade angle, which is effectively adjusted to a 12 o'clock position. Such positive interaction of the two pitch controls may also result in a stress-reducing synergy.

Preferably, a weighting is performed between the azimuth adjustment angle and the blade adjustment angle, so that the value of the azimuth adjustment angle is larger by one azimuth weighting factor than the value of the blade adjustment angle, or that the value of the blade adjustment angle is larger by one blade weighting factor than the value of the azimuth adjustment angle, whereby the azimuth weighting factor and the blade weighting factor are each larger than 1.2, preferably larger than 1.5 and, in particular, larger than 2. It is thus ensured that in relation to a 12 o'clock position, the two adjustment angles, i.e., the azimuth adjustment angle and the blade adjustment angle, have different values. What is avoided, in particular, is an effective pitch control in relation to a 12 o'clock position.

A method is thus proposed, which solves or reduces the problems caused by a wind height profile such that the azimuth position of the wind turbine is adjusted and that, in addition or as an option, the rotor blade is cyclically adjusted in its blade angle. Depending on the position of the rotor blade, a wind height profile may lead to a variation of the angle of incidence at the rotor blade. The angular difference leads to different lift coefficients.

The concrete wind height profile may also depend on location, direction and/or season, and the proposed compensation measures may depend on the concrete height profile. Preferably, it is proposed to perform the azimuth adjustment and/or blade adjustment depending on such height profile. It is proposed, in particular, to select the azimuth adjustment angles depending on the height profile, and to moreover, or as an alternative, select the blade adjustment angle depending on the height profile.

For a cyclic alteration of the blade angle of each rotor blade, it is proposed, in particular, to perform such alteration depending on a continuous curve, whereby such curve or, respectively, characteristic provides basically continuously a rotor blade angle for each position of a circulation of the respective rotor blade.

Preferably, the indication of corresponding values in a table and/or their consideration in a functional context will also depend on location, season, direction and height and/or on the prevailing turbulences.

Such prerecorded values, whether in a table, in a functional context or otherwise, may be moreover, or as an alternative, adjusted on site, for example metrologically; what is proposed here, in particular, is an adaptive adjustment.

### BRIEF DESCRIPTION OF THE SEVERAL VIEWS OF THE DRAWINGS

The invention is described in more detail below based on exemplary embodiments with reference to the accompanying figures.

FIG. 1 shows a schematic perspective view of a wind turbine.

FIG. 2 shows an exemplary height profile of the wind in relation to a schematically rendered wind turbine.

FIG. 3 shows, in the form of a diagram, an example of an azimuthal angle-dependent blade angle or, respectively, angle of incidence, including compensation, of a rotor blade.

FIG. 4 shows an example of an azimuthal angle-dependent local blade angle or, respectively, angle of incidence in a diagram for different azimuth adjustments.

### DETAILED DESCRIPTION

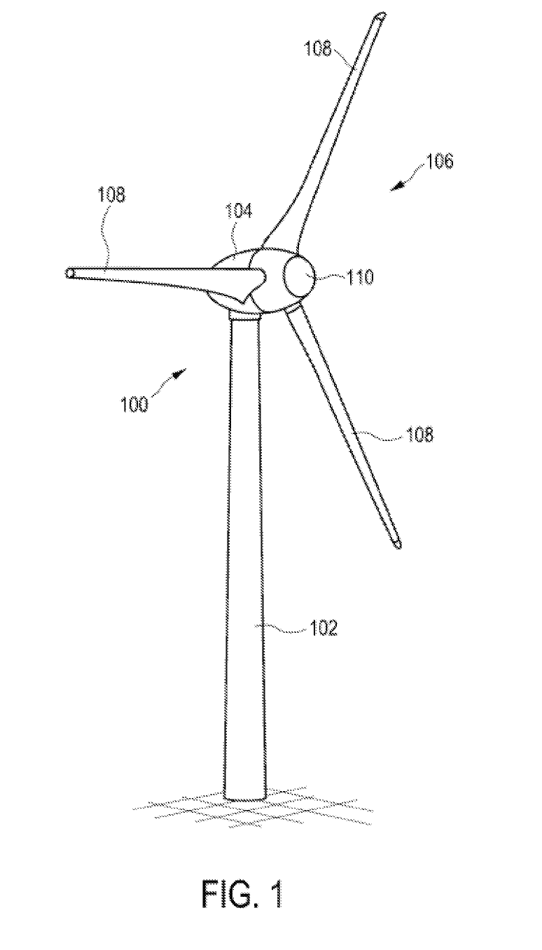

FIG. 1 shows a wind turbine 100 with a tower 102 and nacelle 104. A rotor 106 with three rotor blades 108 and a spinner 110 is located on the nacelle 104. The rotor 106 is set in operation by the wind in a rotating movement and thereby drives a generator in the nacelle 104.

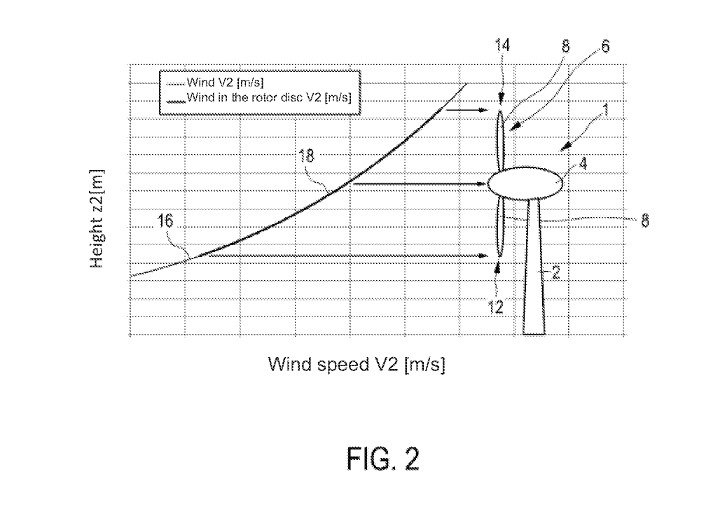

FIG. 2 through 4 are based on simplistically calculated or, respectively, simulated values.

FIG. 2 is based on an exemplary wind turbine 1 with a hub height of around 85 m. The wind turbine features a nacelle 4 with a rotor 6 having rotor blades 8. The wind turbine 1 stands on a base with its tower 2, which base is said to be 0 m high and thus forms the reference parameter for height.

The rotor blades 8 over-sweep a rotor field that is defined by a rotor disc and that extends from a minimum height 12 of 44 m to a maximum height 14 of about 126 m.

What is moreover shown is a height profile of the wind 16, showing the wind speed V2 subject to the height z2. The wind speed V2 is shown in [m/s] at the abscissa, and the height z2 is shown in [m] at the ordinate. The height profile portion 18, which is arranged within the rotor disc, i.e., between the minimum height 12 and the maximum height 14, is shown in bold in FIG. 2.

The wind speed thus extends from the minimum height 12 to the maximum height 14, whereby it is just above 7 m/s in the area of the minimum height 12. At the maximum height 14, the wind speed reaches about 11.6 m/s. This results in a height coefficient of around 1.6.

The diagram in FIG. 2 shows a height profile of the wind with a height exponent of a=0.5.

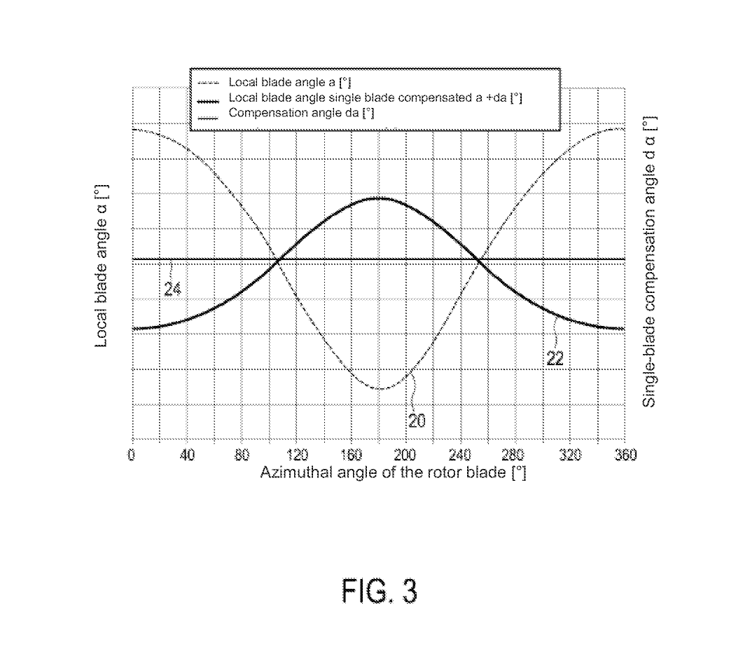

FIG. 3 shows, with regard to the exemplary wind height profile and the wind turbine 1 shown in FIG. 2, the local blade angle depending on the azimuthal angle of the respective rotor blade, namely the actual blade angle to the apparent wind that actually exists or that has been estimated through calculation. At the abscissa of the diagram, the azimuthal angle of the rotor blade is specified as degrees, with 0° or, respectively, 360° equaling a 12 o'clock position of the rotor blade. The local blade angle 20, which indicates the angle of incidence to the existing or, respectively, calculated apparent wind, changes from 9.4° at the 12 o'clock position up to 5.7° at the 6 o'clock position, the azimuthal angle of which is, accordingly, 180° . The angles of the local blade angle are shown, as examples, at the left-hand ordinate in the diagram.

It is now proposed to adjust the rotor blade angle in dependence on the azimuthal angle of the rotor blade such that the local blade angle assumes as constant a value as possible, meaning that the angle of incidence is constant over the entire circle of rotation, i.e., over the entire range from 0 to 360° of the azimuthal angle of the rotor blade. According to one embodiment, it is proposed in this context to add a single-blade compensation angle 22, which may be also referred to as the blade adjustment angle. The blade compensation angle 22 varies over the azimuthal angle of the rotor blade from about −1.8 to +1.8°, and its values are entered at the right-hand ordinate in the diagram according to the course shown in FIG. 3. It should be noted that the scaling of the blade compensation angle according to the right ordinate differs by factor 2 from the scaling of the local blade angle according to the left ordinate. By adding such blade compensation angle 22, the local blade angle may be ideally compensated such as to assume a mean value as its constant value, with the actual value depending, of course, on the actual ancillary conditions, in particular on the actual wind turbine. Accordingly, the compensated local blade angle 24 is shown as a horizontal line in the diagram of FIG. 3. The result of an exact, constant, compensated local blade angle can be arrived at mathematically and may vary in reality.

The variation of the angle of incidence at the rotor blade due to the wind height profile may be also referred to as the fluctuation of the local blade angle at the rotor blade, and should be reduced or prevented altogether, if possible. This means that if the rotor blades of a wind turbine rotor hub are stationary, there will be a fluctuation of the local blade angle during operation, which is shown in the form of the characteristic 20 of the local blade angle. If each and every single rotor blade is suitably adjusted—i.e., pitched—in its rotor blade angle, as illustrated by the blade compensation angle curve 22, then blade angle fluctuation can be compensated. This way, one will achieve a completely even, ideal blade angle for this rotor radius at each position of the rotating blade, as illustrated by means of the curve 24, which shows the compensated blade angle. Hereby, one may reduce both loads and noise. Due to such equalization of the blade angle, and thus of the wind flow approaching the rotor blade, the blade can be turned, or rather pitched, more into the wind to increase the output.

The diagram of FIG. 3 shows an example of a wind turbine with compensation of the blade angle fluctuation at an average wind speed in the area of hub 4 of about 10 m/s and a blade tip speed of v_{Tip}=78 m/s. The local blade angle 20 relates to a radius of 35.5 m.

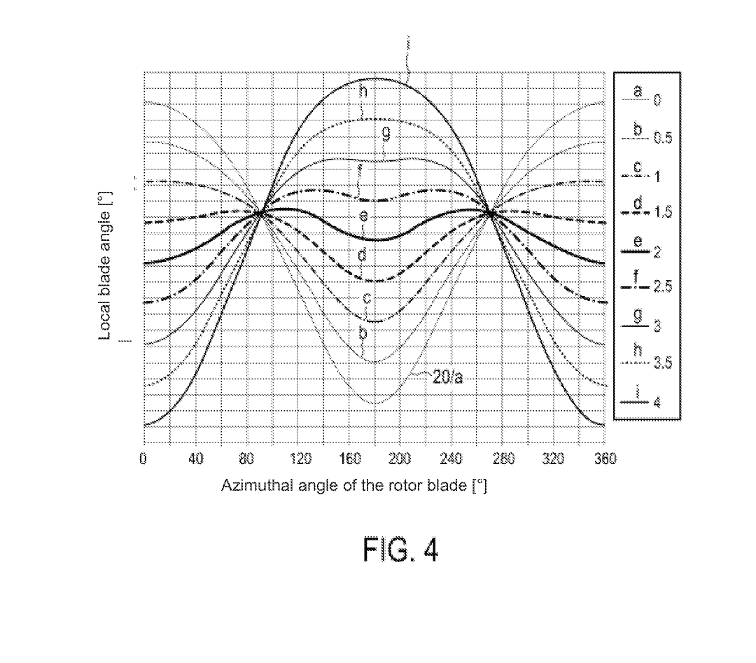

FIG. 4 shows an ideal or additional means for achieving an equalization of the local blade angle or, respectively, angle of incidence of the apparent wind. FIG. 4 shows the local blade angle 20 for an azimuth position, where the nacelle 4 (according to FIG. 2) is facing directly into the wind. Such curve is also marked with the letter a and equals the local blade angle 20 of FIG. 3. Here, too, a wind turbine 1 and a wind height profile according to FIG. 3 has been taken as a basis. Here, as in FIG. 3, the local blade angle 20 is also measured against the azimuthal angle of the rotor blade, which is charted at the abscissa with values between 0 and 360°.

To the right of the diagram, there is a legend for the azimuth deviations from the wind turbine, namely a to i, with a describing the local blade angle 20 for an azimuth position that is facing directly into the wind and is thus adjusted by 0°. Further courses of the local blade angle are shown for deviations of the azimuth position curve b to the point of curve i. It shows that curve e exhibits the least fluctuation, namely at the 12 o'clock position up to, approximately, a 10 o'clock position or, respectively, a 2 o'clock position. In this example, curve e appertains to an adjustment of the azimuth position. This means that by simply adjusting the azimuth angle, one may, in particular, achieve a constant and significant equalization of the local blade angle and thus a significant equalization of the loads at the rotor blade. It is thus advantageous to provide a constant offset angle, i.e., a constant correction or adjustment angle for the azimuth position.

So, when looking down onto the wind turbine, the nacelle, and thus the rotor axis of the wind turbine, is turned clockwise about the azimuth angle, in particular about the azimuth adjustment angle. The values of the local blade angles at the rotor blade start to even out with regard to the nacelle's alignment with the rotor axis pointing downwind. The fluctuation of the local blade angle is clearly reduced when an offset in the azimuth angle is created between rotor axis and wind direction.

This, too, results in a reduction in loads and noise. If this leads to the above-described equalization of the blade angle and wind flow approaching the rotor blade, the blade can be turned more into the wind to increase the output.

1. A method for operating a wind turbine having a rotor with rotor blades and a substantially horizontal rotation axis for generating electrical energy from wind energy, the method comprising at least one of the following:
aligning the wind turbine such that the azimuth position of the wind turbine departs by an azimuth adjustment angle from an alignment into the wind; and
adjusting the rotor blade angle of the rotor blades in cyclic rotation so as to reduce alternating loads that are caused by a height profile of the wind.

2. The method according to claim 1, wherein the wind turbine departs to the right from the alignment into the wind when looking from the wind turbine the direction of the wind, or, respectively, departs in the azimuth position clockwise to the alignment into the wind when looking down onto the wind turbine.

3. The method according to claim 1, wherein the azimuth adjustment angle is between 0.5 to 10°.

4. The method according to claim 1, further comprising adjusting the azimuth adjustment angle based on the prevailing wind speed.

5. The method according to claim 1, wherein each of the blade angles is adjusted in cyclic rotation such that an angle of incidence is kept substantially constant in an area of the blade tip.

6. The method according to claim 1 wherein the blade angle of each rotor blade is adjusted by predetermined values, depending on the respective rotor blade's cycle position, wherein predetermined values have been previously recorded in a table or provided by a function that depends on cycle position.

7. The method according to claim 1, wherein the blade angle of each rotor blade is controlled individually and depending on the prevailing wind speed and cycle position of the respective rotor blade.

8. The method according to claim 1, wherein a common normal rotor blade angle is specified for all rotor blades when in operation, and each rotor blade is varied around the common normal rotor blade angle depending on the respective rotor blade's cycle position.

9. The method according to claim 1, wherein the wind turbine operates at a profile operating point that differs from a normal operating point, wherein:
the normal operating point includes a normal blade angle that is designed for the prevailing wind, but without consideration of a wind profile, and includes a normal alignment of the azimuth position into the wind and
the profile operating point provides a profile azimuth position that deviates by the azimuth adjustment angle from the normal alignment, and includes a profile blade angle that deviates by a blade adjustment angle from the normal blade angle.

10. The method according to claim 9, wherein:
a first profile operation is selected, where the blade adjustment angle in a 12 o'clock position of the respective rotor blade is opposite the azimuth adjustment angle, or
a second profile operation is selected, where the blade adjustment angle and azimuth adjustment angle adjust the rotor blade in the same direction in relation to a 12 o'clock position of the respective rotor blade.

11. The method according to claim 9, wherein a weighting is performed between the azimuth adjustment angle and the blade adjustment angle so that a value of the azimuth adjustment angle is larger by one azimuth weighting factor than a value of the blade adjustment angle, or that the value of the blade adjustment angle is larger by one blade weighting factor than the value of the azimuth adjustment angle, wherein the azimuth weighting factor and the blade weighting factor are each larger than 1.2.

12. A wind turbine comprising:
a rotor with rotor blades and a substantially horizontal rotation axis for generating electrical energy from wind energy, wherein the wind turbine is being operated using the method according to claim 1.

13. The method according to claim 3, wherein the azimuth adjustment angle is between 1 and 3.5°.

14. The method according to claim 11, wherein the azimuth weighting factor and the blade weighting factor are each larger than 2.

15. A method of operating a wind turbine having a plurality of rotor blades, the method comprising:
detecting the wind speed;
adjusting an azimuth position of the wind turbine by an azimuth adjustment angle based on the wind speed, wherein the azimuth position aligns the wind turbine into the wind, wherein the azimuth adjustment angle is decreased when the wind speed decreases and the azimuth adjustment angle is increased when the wind speed increases; and
operating the wind turbine at the selected azimuth adjustment angle.
